(19) United States
(12) Patent Application Publication
(10) Pub. No.: US 2020/0080039 A1
(43) Pub. Date: Mar. 12, 2020

(54) FLOATING FACILITY AND METHOD FOR MATURATION OF ALCOHOL SPIRITS

(71) Applicant: Brown Water Spirits LLC, Nashville, TN (US)

(72) Inventor: Orrin Henry Ingram, III, Nashville, TN (US)

(21) Appl. No.: 16/681,158

(22) Filed: Nov. 12, 2019

Related U.S. Application Data
(63) Continuation of application No. 15/815,802, filed on Nov. 17, 2017.
(60) Provisional application No. 62/424,005, filed on Nov. 18, 2016.

(51) Int. Cl. C12H 1/22; C12H 1/20; C12G 3/07

(52) U.S. Cl. CPC C12H 1/22; C12G 3/07; C12H 1/20

(57) ABSTRACT

An alcohol spirit maturation facility such as a barge or another large metal construction storage area is placed on a body of water. Racks may be placed in the storage area and filled with barrels or other containers holding alcohol spirits. The steel construction of the facility draws in and stores solar energy as heat and radiates that heat into the storage area. After the sun sets, the body of water serves as a heat sink to draw away heat. This creates more drastic temperature changes which may benefit the maturation process of stored spirits. Additionally, the natural movements and oscillations of a stationary floating facility as a result of currents, waves, and passing vessels creates a passive churning effect for containers and barrels stored therein. This combination of increased temperature and passive churning may accelerate the maturation process of alcohol spirits.

### PRIORITY

This application is a non-provisional application claiming priority to U.S. Provisional Application 62/424,005, filed Nov. 18, 2016, having the same title as this application and the disclosure of which is incorporated herein by reference.

### FIELD

The disclosed technology pertains to a system for using a floating facility to age alcohol spirits.

### BACKGROUND

Many conventional maturation practices for a variety of alcohol spirits require a liquid to be stored in specialized containers and conditions for a period of time to allow it to mature, ferment, or otherwise develop into a final product. For example, in the whiskey industry, spirits rest in wood barrels in rick houses for extended periods of time until the flavors of the wood are sufficiently imparted into the spirit contained in the barrel. The production of premium whiskey usually takes 4 to 12 or more years of storage within a rick house. The upper-most portion of the rick house is considered best for premium products, an area which may only include about 5-10% of the total usable storage space of the rick house. With such a small area available for ideal storage, and a lengthy time needed for maturation, production of premium whiskey comes at a high cost.

Like other distilled spirits, whiskey does not contain any live cultures from which to draw a final flavor and must instead rely on the interaction between the spirit and the charred inner walls, i.e., the “interior aging surface,” of a barrel for maturation. Since the wooden inner wall of the charred barrel is somewhat porous, the liquids contained therein over time will seep into and out of the wood, bringing sugars and other flavors with it. This exchange of caramelized sugars is greater in areas of extreme temperature fluctuation, as changes in temperature cause the wooden inner wall to become more or less porous. As temperature increases, the liquid in the barrel expands and liquid flows into the now more porous surface of the inner wall. When the wood cools and contracts, a small amount of spirit that was absorbed into the wood is expelled as it becomes less porous. The expelled spirit contains high concentrations of sugar from the wood which is diffused throughout the barrel somewhat slowly, since the barrel is at rest in storage. Maximizing temperature changes also maximizes this exchange and the introduction of sugars and flavors. This explains why the uppermost portions of a rick house are most ideal for storage, since this area will maximize exposure to solar energy conducted through the roof of a rick house, as well as convective energy from heated air which will rise and become trapped in the uppermost portions of the rick house.

Another important factor in storage is humidity. In a more humid environment, a wooden storage container will naturally retain some moisture in its outer wall, which may reduce the amount of contained liquid that may seep all the way through the barrel wall and evaporate or leak from the surface of the outer wall. Humidity also plays a factor in keeping seams and seals around the top and bottom portion of the barrel and between the wooden slats moisturized and adequately sealed. The result is that, in a properly humid environment, the amount of spirits that leaks or evaporates from a barrel during maturation will be less than in a very dry environment. In the bourbon industry, the portion of spirits lost in this manner is referred to as the “Angel's Share” and, depending upon storage conditions and maturation time, can sometimes exceed 50% of the contents of the barrel being lost before it can be bottled and sold.

While the conventional storage and maturation methods are relatively low in cost, they are inefficient in terms of the time required for maturation and the available storage space that is considered premium or ideal. Because a barrel is placed in a rick house and then essentially undisturbed for 4 to 12 years, save for perhaps basic visual inspection from time to time, the maturation process relies greatly upon factors such as gravity and fluid mixing caused by differing temperatures across a container of liquid in order to draw sugars out of the wooden inner wall and disperse those sugars throughout the container. If other forces were introduced to increase fluid interaction with the wooden inner wall or mix the liquid contents this maturation process could be shortened. The more the liquid stirs within its barrel, the surface area of the barrel interior is effectively increased and the contact between the spirit and the surface responsible for maturation similarly increases. However, conventional methods of stirring or churning containers may require complex and expensive machinery and systems, as well as increase power consumption and costs of maturation.

By maintaining a proper humidity level and also reducing the time required for maturation as mentioned above, the Angel's Share that is lost can also be reduced. The result of such an improved process could be a spirit whose discernible maturity level exceeds the actual time spent maturing, and which produces a greater amount of usable liquid per container after maturation.

What is needed, therefore, is an improved system and method for maturing alcohol spirits that is both scalable and efficient.

### BRIEF DESCRIPTION OF THE DRAWINGS

The drawings and detailed description that follow are intended to be merely illustrative and are not intended to limit the scope of the invention as contemplated by the inventors.

FIG. 1 is a perspective view of an exemplary storage facility for maturing alcohol spirits.

FIG. 2 is a perspective view of an exemplary storage facility moored in a storage location.

FIG. 3 is a side view of another exemplary storage facility that may be moored in a storage location.

FIG. 4 is a front elevation view of an exemplary storage rack for barrels.

FIG. 5 is a graph showing an exemplary set of temperature data gathered from the interior of an exemplary storage facility over a period of several months.

FIG. 6 is a graph showing an exemplary set of temperature data gathered from the interior of an exemplary storage facility and from a conventional rick house over a period of several months.

FIG. 7 is a front perspective view of an exemplary storage rack for barrels showing dimensional measurements.

FIG. 8 is a front perspective view of an exemplary barrel showing dimensional measurements.

FIG. 9 is a side perspective view of an exemplary block of racks.

FIG. 10 is a top down view of an exemplary layout for storage racks within a barge.

### DETAILED DESCRIPTION

The inventor has conceived of novel technology that, for the purpose of illustration, is disclosed herein as applied in the context of alcohol spirit maturation processes. While the disclosed applications of the inventor's technology satisfy a long-felt but unmet need in the art of alcohol spirit maturation processes, it should be understood that the inventor's technology is not limited to being implemented in the precise manners set forth herein, but could be implemented in other manner without undue experimentation by those of ordinary skill in the art in light of this disclosure. Accordingly, the examples set forth herein should be understood as being illustrative only, and should not be treated as limiting.

While conventional maturation process facilities are in some ways adequate, there exists a potential for improved efficiency in maturation storage by using storage facilities that take advantage of one or more passively available characteristics or conditions of an improved storage facility and storage location. By introducing and maximizing the effects of passively available characteristics or conditions a maturation storage facility can be created that may improve the speed of maturation and reduce loss of spirits due to leakage without introducing complex or expensive systems that may have a high energy cost. Passively available characteristics, i.e., “passive aging features,” may depend on the location of the storage facility and may include, for example, exposure to direct sunlight, contact with materials that are exposed to direct sunlight, contact with a body of water, contact with a flowing or moving body of water, exposure to high winds, geothermal energy, other characteristics that may introduce a passively available source of energy (e.g., exposure to direct sunlight), passively available desirable characteristics (e.g. humid air from a nearby body of water), and combinations thereof. While not necessarily true in all cases, many passively available characteristics are associated with being renewable or naturally occuring sources of energy or other resources.

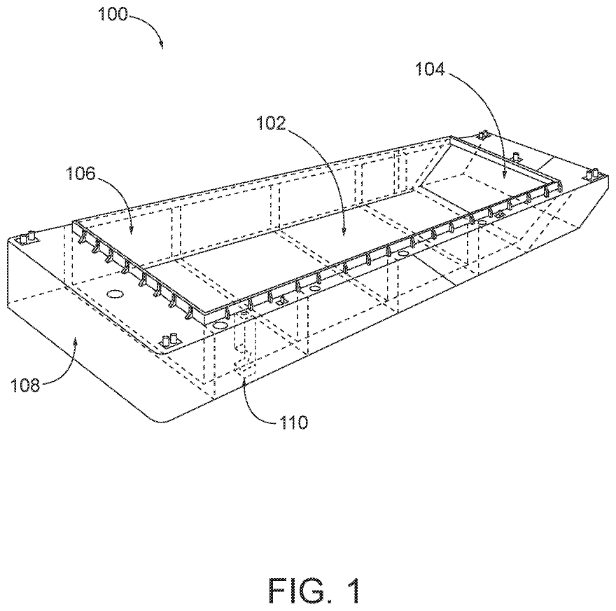

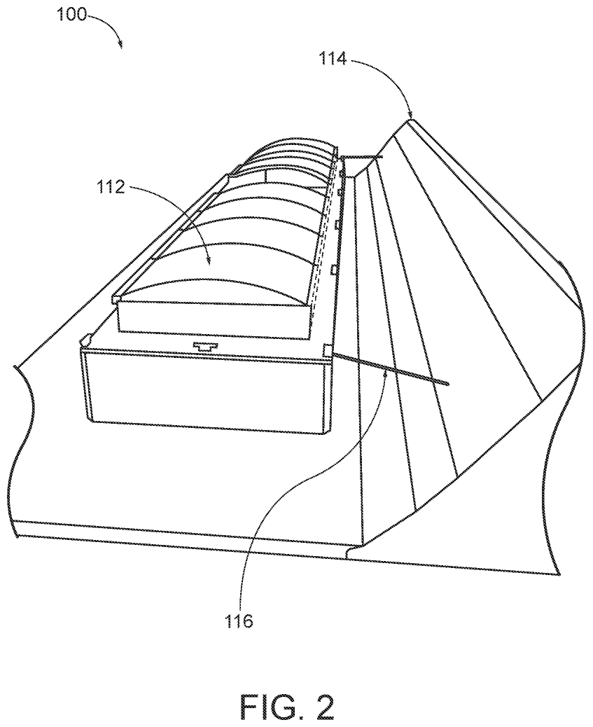

Turning now to the figures, FIGS. 1 and 2 show one exemplary facility for storing alcohol spirits during maturation, a hopper barge (100). While the examples described below may often refer to the facility as a barge (100), it should be understood that a variety of different types of spirit aging facilities are encompassed herein including not only barges, but other floating structures or vessels having a variety of suitable shapes and sizes, and that would function similarly. A barge or other floating facility may be placed on a lake, a river, or even in the ocean and may take advantage of passive characteristics such as the sun, the water that it floats upon, any motions or movements of that water, and the naturally occuring level of humidity near the body of water it floats upon. Exemplary spirit aging facilities may have any suitable dimensions. Useful storage facilities may be from about 180 to about 300 feet long, or from about 180 to about 210 feet long, and from about 25 to about 55 feet wide, or from about 25 to about 50 feet wide, and from about 10 to about 20 feet deep, or from about 15 to about 17 feet deep.

A hopper barge (100) such as that in FIG. 1 may be a decommissioned barge that has been used for other purposes, or may be built specifically for maturation storage. One example of a hopper barge (100) measures about 195 feet in length, about 35 feet in width, and about 17 feet in depth. Such a barge, when outfitted for barrel storage, could accommodate from about 2000 to about 2500 53-gallon barrels commonly used for alcohol spirit maturation within its storage area (102). The dimensions and storage capabilities described above are exemplary, and it should be understood that a barge, facility, or floating structure of nearly any size or dimensions (e.g. less than or greater than about 195 feet in length, less than or greater than about 35 feet in width, and less than or greater than about 17 feet in depth) could be used with the process described herein, with larger facilities offering advantages of scalability and high-volume storage. Facility construction and materials may vary, but typically a facility may be constructed from durable materials that also offer a high level of thermal conductivity (e.g., metals such as steel, thermally conductive plastics, fiberglass). Facility choice may depend upon factors such as cost (e.g. a new barge or custom facility as opposed to a decommissioned barge), mooring location (e.g. a facility with very large dimension being appropriate for a wide river and a facility with smaller dimensions being appropriate for a narrow river), desired capacity, scalability, and other factors.

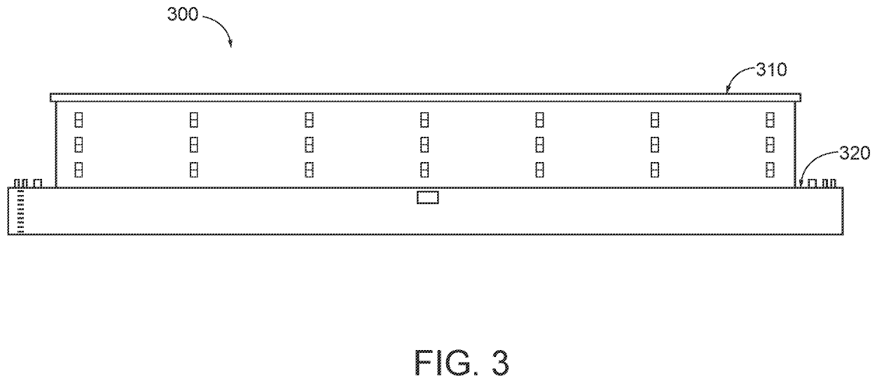

Referring now to FIG. 3 another exemplary spirit aging facility (300) is shown.

The spirit aging facility comprises a rick house (310) that is disposed upon and supported by a barge (320). The exemplary spirit aging facility may be configured to store up to about 5,000 53-gallon barrels.

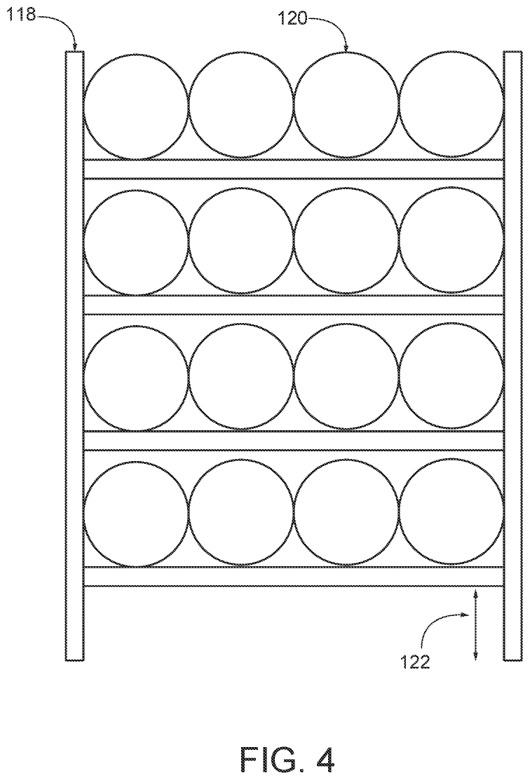

Referring to FIG. 4, the floor height (122) of the racks (118) may be varied to prevent stored barrels (120) from being exposed to water that may pool on the floor of the storage area (102) as a result of condensation or rainfall until the pump system (110) can remove it. Particular types, dimensions, and material used to construct racks (118, 300) and barrels (120) will vary by a particular implementation, with such options being apparent to one of ordinary skill in the art in light of the disclosure herein. For example, racks (118, 300) may be made of wood, plastic, metal, or other appropriate materials. Barrel (120) or container construction will vary by the type of alcohol spirit that is being matured. For example, whiskey barrels are created from particular types of wood and are often charred on the inside before the alcohol spirits are added.

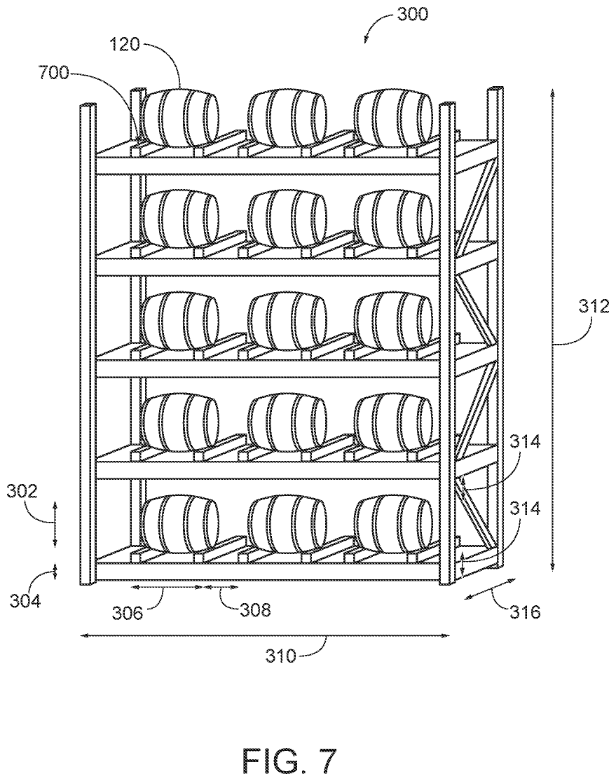

For example, a barge (100) may be constructed of walls (106) of an appropriate material (e.g. steel, aluminum, thermally conductive polymer or plastic), including a bow (104), a stern (108) and a deck, and may in some cases feature a double skin design with approximately six separate void tanks between the two hulls. A pump system (110) may be used to control the amount of water within the storage area (102). The hopper storage area may be covered by approximately nine fiberglass covers (112), each weighing between about 2100 and 2400 pounds. Such a hopper barge (100) may be moored by cables (116) to a naturally occurring bank or a manmade mooring structure (114). A series of racks, comprising a plurality of racks, for example racks such as the rack (118) shown in FIG. 4 and/or the rack (300) shown in FIG. 7, may be arranged within the storage area (102) and filled with barrels (120) of alcohol spirits for maturation storage. Referring now to FIG. 7, such racks (300) may have a system of spacers or grooves (700) to firmly seat barrels (120) in place and also allow for free flow of air about most or all of the surface of the barrels (120).

There are a number of advantages to such a hopper barge (100). In addition to a high storage capacity in the storage area (102), such a barge allows for easy access to contents due to the large removable covers (112) and the storage area (102) design allows for loading and unloading by heavy machinery, such as cranes, if desirable. This could allow a crane operator to, for example, add or remove entire racks (118, 300) of barrels (120) at a time. The steel plate construction of the hopper barge (100) provides some advantages in creating the temperature variations that are desirable in many maturation processes. During the day time when the barge top and walls are exposed to direct sunlight, the steel plate will heat up and conduct a significant amount of heat into the interior storage area (102), which may allow the storage area to reach temperatures of 110 degrees Fahrenheit or more during the summer months. The conductive nature of the steel construction combined with the fiberglass covers (112) creates a sort of greenhouse effect, whereby heat is conducted into the storage area (102) through the steel walls and then becomes trapped under the fiberglass covers which are less conductive. Due to the shallow depth of the barge, at about 17 feet as compared to the 50-80 feet of a conventional rick house, there will be much less difference in temperature between a barrel stored near the top of the storage area (102) and one stored near the bottom. As a result, a very high percentage of the storage area (102) may be considered ideal or premium storage for barrels where temperature changes are desirable and, as a result, there is less variation in quality of barrels from the same facility.

As the sun sets and ceases heating the walls and deck of the barge, the interior temperature of the storage area (102) will begin to fall as the water that the barge rests upon or which flows past the barge will serve as a heat sink, drawing heat out of the steel walls and floor and quickly dispersing it. With the ability to harness the energy of the sun to rapidly heat the storage area (102) beyond ambient temperatures, and the heat soaking effect of the surrounding waters to rapidly cool it, an optimized storage situation is created for many alcohol spirits.

An additional advantage of the barge (100) of FIG. 1 is the natural motions of the water upon which the barge sits, or which flow past the barge. The barge (100) may be dynamically anchored to its mooring by a set of cables of varying lengths, to allow for oscillation and movement of the barge in the surrounding waters. Whether it is the gentle motions of a lake or slow-moving river, forces created by another vessel moving nearby, or the strong force of water from a fast-flowing river or choppy sea, the movement of water past and below a floating barge translates into motion and forces for the contents of the storage area (102), such as racks (118, 300) and the barrels (120) they hold. As that motion reaches the barrels (120) it will cause alcohol spirits contained inside to move and stir about within the barrel, which will both disperse the sugars and flavors more evenly throughout the barrel and cause an increased flow of alcohol spirits to flow against and seep into the porous inner walls of the barrel, relative to a barrel that is completely at rest and not influenced by any outside movements. Over time this additional motion and the resulting churning effect may increase the speed at which sugars are pulled from the wood inner wall of the barrel and dispersed throughout the full volume of alcohol spirits.

Another advantage of the barge (100) of FIG. 1 is its proximity to and contact with a body of water. Conventional rick houses are typically open to the elements and are not temperature or humidity controlled. The ideal storage area is in the topmost portion of the large building since it maximizes changes in temperature, but this is also the area of the rick house with the least humidity. As a result, barrels stored there may take on the largest amount of desirable sugars and flavors in the least amount of time, but the portion of spirits lost to evaporation and leaking is also greater than that of a barrel stored below. The storage area (102) shown in FIG. 1 may be easier to maintain at ideal humidity levels because of several factors. For example, being at rest on a river, lake, or other body of water, the storage area (102) will be naturally subject to a more humid climate as compared to an open-air rick house built on land. Additionally, the storage area (102) will take on water from condensation and rainfall. While water in the storage area (102) would desirably not reach a level where barrels (120) are directly exposed, water that is pooled in the bottom of the storage area (102) will heat and evaporate as the barge (100) heats in the sunlight creating a potentially very humid environment within the storage area (102). In some implementations, the overall level of humidity may be controlled by using the pumps (110) to control the level of water at rest in the storage area (102), with some amount of standing water contributing to a humid environment as it heats and cools and a completely pumped and dry storage area (102) tending towards a less humid environment. In other implementations however, humidity may be maintained at near ideal levels in a completely passive manner by waterproofing and sealing efforts applied to the interior and exterior of the storage area (102).

Variables such as facility type, whether a commercially available barge or custom construction, construction material, size, and other factors may vary by particular implementation and such options will be apparent to one of ordinary skill in the art in light of the disclosure herein. For example, as an alternative to the above disclosed hopper barge (100), a steel lift top barge may also provide advantages when used as a maturations storage facility. A steel lift top barge commonly has a single large storage area, similar to a hopper barge. In contrast to the fiberglass covers (112) of a hopper barge, a steel lift top barge has steel plate covers that cover the hopper. Steel lift top barges may be commercially available in similar sizes and storage capacities as hopper barges (100).

Another example of a barge that may be used is a tank barge measuring about 195 feet in length, about 35 feet in width, and about 15 feet in depth. Such a barge, when outfitted for barrel storage, could accommodate from about 1,200 to about 2,000 barrels of the size commonly used for alcohol spirit maturation. A tank barge may be constructed of steel plate and feature a double skin design with approximately six separate void tanks between the two hulls, as well as six separate compartments within the cargo area, each individually accessible by a steel hatch. A multi-compartment design may offer the advantage of being able to have varying humidity levels in different compartments, as some types of alcohol spirits may desirably have differing storage requirements where humidity is concerned. Other types of facilities for storage on or in a body of water will be apparent to one of ordinary skill in the art in light of the disclosure herein. While a hopper barge, steel lift barge, and tank barge have been discussed and some advantages of each noted, it should be understood that other barges of various sizes or even a specially constructed floating facility could take advantage of one or more of the passive characteristics of a floating maturation storage facility. For example, some unit tow barges can be about 400 feet or longer, and may offer maturation storage volumes several times greater than those disclosed above. As another even larger example, some ocean-going cargo ships may exceed about 1000 feet in length and about 180 feet in width, and could be loaded with containers of alcohol spirits for maturation and moored in an area with heavy sea motions to take advantage of such churning effects to aid the maturation process.

A maturation storage facility, such as a barge (100), may additionally have installed monitors and sensors that may aid both in security as well as gathering data related to the maturation process. For example, a facility such as a barge may have data gathering sensors, such as thermometers for capturing temperature data, hydrometers for capturing humidity data, and accelerometers for capturing motion data. Captured data may be manually retrieved or wirelessly broadcast to other locations. Such data may be used in an ongoing manner to provide monitoring capabilities and alerts to administrators, or may be used in the aggregate to improve and further enhance the efficiency of facilities over time. For example, temperature and humidity data may be available for a particular batch of matured spirits that is particularly well received by consumers, and can be used to determine and recreate the conditions that led to the desirable product. Captured data may also be used by a computer to determine a rack house equivalent age of a barrel of spirits. For example, if the capture data determines that, due to increased temperature variance and churning, the interactions of spirits within a barge aged barrel occurring during an 18-month period are equivalent to the interactions of spirits within a rack house aged barrel occurring during a 24-month period, such a determination could be used to market, categorize, or otherwise designate the barge aged barrel.

Alternately, the data may be used to determine that a particular facility is not utilizing solar energy effectively, and may need to be painted, cleaned, or otherwise maintained, or that a particular facility is far too humid inside, indicating a leak or a failed pump, or that a particular facility is not moving and oscillating within the water as much as desired, indicating that mooring cables may need to be loosened or adjusted, or that debris has gathered around the barge and is preventing easy movement. Additional sensors may include fire alarms, motion sensors, oxygen sensors, and the like, and may be used to detect and respond to various related dangers or events, such as fires, vandalism, intruders, and the like.

While many of the advantages of the disclosed maturation storage facility stem from the low cost of the passive characteristics it takes advantage of to speed the maturation process, some implementations of the technology herein may use some active systems or other modifications to enhance or further capture the effect of the passive characteristics. Some exemplary maturation storage facilities may comprise an active system or modification that can be used alone or in any useful combination of one or more active systems and/or one or more modifications, such as those that are described as follows.

One example may be to use a ballast system to eject water and raise the facility to the surface of a body of water during daytime, to maximize exposure to the sun, and then take water on and lower the facility deeper into the body of water at night, in order to maximize the speed at which the surrounding waters sap heat from the steel body of the facility. Another example may be to use rudders or other control surfaces extending from the sides and bottom of the facility to increase the effect of the surrounding waters on the facility. Such rudders could be passive systems themselves, or could be mechanically or electrically powered to adjust themselves in patterns that will maximize oscillations over time. Another example may be to use racks (118, 300) which are anchored and unable to tip over, but which are hinged at or otherwise attached to the floor or ceiling of the storage area (102) and are balanced to have exaggerated reactions to the overall motion of the barge (100) or facility. With such a rack (118, 300), a slight oscillation caused by flowing water may be translated into a more noticeable rocking motion of the rack (118, 300) itself. Another example may be to install exhaust vents, dehumidifiers, air circulation fans, and/or other climate control features to assist in fine control of temperature and humidity. As another example, the cables (116) of varying lengths that moor the facility to a static location may be dynamically adjusted in length by mechanical or electrical winches or other similar systems. Dynamically adjusting cable (116) length might allow the oscillations, movements, and resulting churning effects of the passing water to be maximized. As one example, a cable may be suddenly increased in length, causing the facility to shift and churn its contents. At a later time, the cable may be shortened back to its original position. Any such active feature that requires power may be powered conventionally, or may be powered by solar panels installed about the facility, or on platforms or other facilities floating nearby.

While many of the above examples rely heavily on passive systems that utilize passive characteristic (e.g. a steel decked barge that stores heat from the sun), it should also be understood that, in addition to using some active systems to magnify the effect of the passive characteristics, the favorable conditions described above for maturation of some alcohol spirits may be recreated entirely indoors using active systems. While this could increase the cost of implementing and maintaining such an alcohol maturation storage facility, it may be desirable in some cases to create such an indoor environment to mature certain premium alcohol spirits with one or more active systems replacing one or more passive systems. For example, one such active facility could use heating and cooling systems to mimic ideal outdoor temperature changes, humidifiers and dehumidifiers to maintain ideal humidity levels, mechanical agitators to cause container storage racks to mix and churn, or all of the above. In this manner, various maturation conditions could be recreated in a controlled environment, which could effectively uncouple the maturation of some alcohol spirits from specific geographic locations and storage environments.

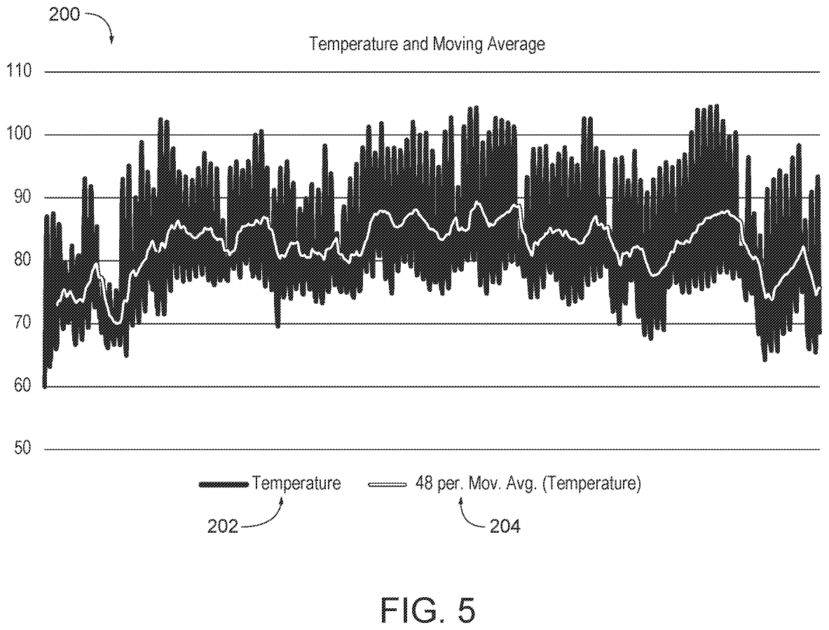

FIG. 5 shows an exemplary data set generated from sensors in an exemplary storage area (102) during a period of several months spanning from spring to fall. FIG. 5 is a graph (200) showing actual temperature (202) and a moving average of temperature (204) for a period of approximately 6 months spanning from spring to fall. As can be seen both in the actual data and the average data, there are regular temperature changes throughout the tracked period of time with daily maximums and minimums varying by as much as 15 to 35 degrees Fahrenheit.

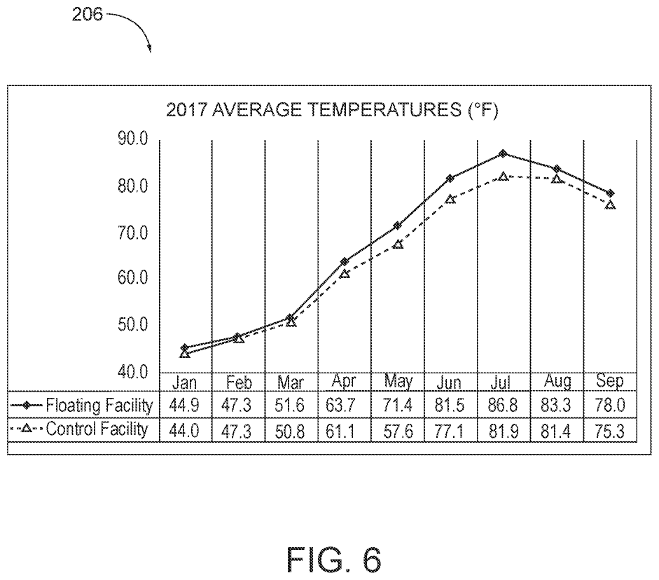

FIG. 6 shows an exemplary data set generated from temperature sensors in an exemplary storage area (102) and from temperature sensors placed in the uppermost portion of a standard rick house, the relatively small area (usually from 5-10% of the total useable storage space) that is typically reserved for aging premium spirits. The data set is collected during a period of nine months spanning from winter to fall, and plotted in the graph shown in FIG. 6. As can be seen in FIG. 6, the average monthly temperature in an exemplary storage area (102) is comparable or higher than that of the average monthly temperature in the uppermost portion of a standard rick house. Thus, the data set suggests that spirits aged in an exemplary storage area (102) in accordance with the present disclosure, experience conditions that are similar, or better, than the conditions experienced by premium spirits that are aged in a standard rick house.

Depending upon the conditions present in an exemplary spirit ageing facility, spirits may be stored in barrels in the spirit aging facility for a time period that is sufficient to obtain a product having desirable characteristics. For example, a plurality of barrels may remain in storage in exemplary spirit ageing facilities for a period of time of between about 4 months to about 72 months, or from about 4 months to about 18 months, or from about 12 months to about 72 months or from about 12 months to about 18 months. In some examples, a plurality of barrels may remain in storage in exemplary spirit ageing facilities for a period of time of at least about 12 months, at least about 16 months, at least about 18 months or at least about 72 months. In some exemplary spirit ageing facilities, the spirit that is aged is whiskey and the desirable characteristic is an aged whiskey.

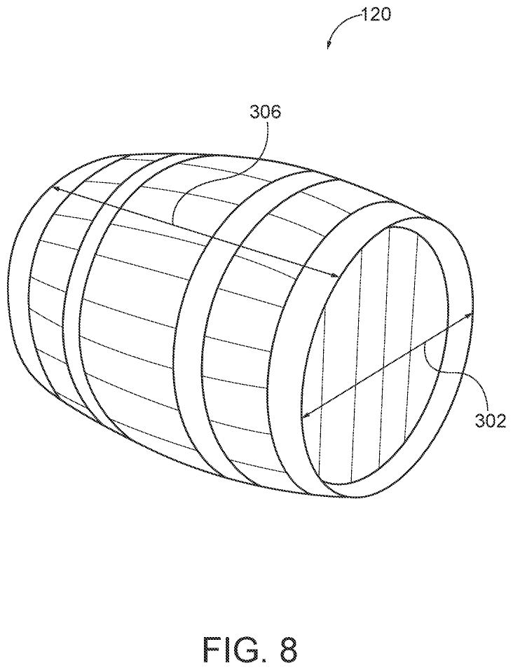

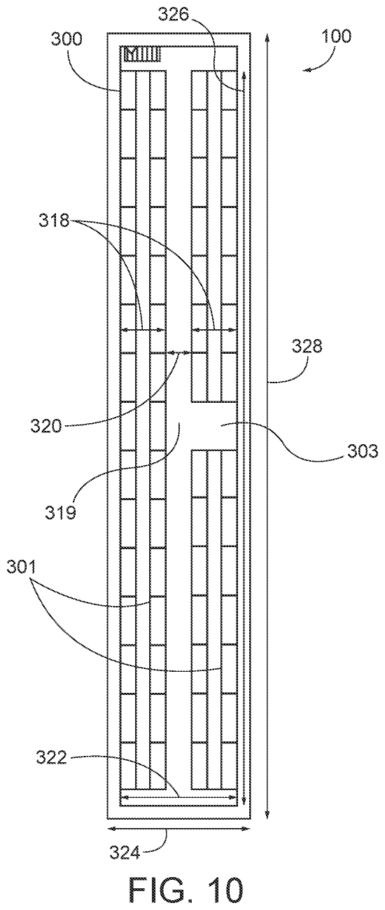

Referring now to FIG. 7, that figure shows dimensional measurements of an exemplary storage rack for barrels. The rack (300) may be constructed from a variety of appropriate materials, such as one or more of wood, metal, polymer, or composites, and may take any suitable form that provides the necessary load bearing strength to account for the mass of the filled barrels and the movements of the barge on water. The dimensional measurements of FIG. 7 are examples only, and some variation in particular dimensions is possible, and will be apparent to one of ordinary skill in the art in light of the disclosure herein. Variations in dimensional measurements may be desirable to take advantage of barges having different interior dimensions, to vary the flow of air around the outside of the barrel, or for other reasons. The storage rack (300) of FIG. 7 has dimensions appropriate for storing a barrel (120) such as that shown in FIG. 8 within a barge such as that shown in FIG. 10. However, as noted, the storage rack (300) could be used in the shown form or with some variations with a variety of barrels and barges.

The exemplary barrel (120) is shown having a diameter (302) of about 24 inches, and a length (306) of about 36 inches. The exemplary storage rack (300) is configured to hold 15 barrels (120) across 3 columns and 5 rows. The rack (300) has a length (310) of about 144 inches, a height (312) of about 160 inches, a depth (316) of about 24 inches, and is lifted (304) about 5.5 inches above the floor. Such a rack (300) can accommodate a row of 3 barrels (120), each being about 36 inches long (306) and being separated from each other by a space (308) of about 12 inches. The barrel (120) may be positioned, by holders, within a row having a space (314) of about 4 inches of clearance above and below the barrel (120). Configured in this manner, a column of five barrels (120), each requiring about 32 inches of vertical clearance (e.g., the diameter (302) of the barrel and the surrounding space (314)), fits within the about 160-inch height (312) of the rack. A row of three barrels (120), each requiring about 48 inches of horizontal clearance (e.g., the length of the barrel (306) and the space (308) between the next barrel or the edge of the rack), fits within the about 144-inch length (310) of the rack.

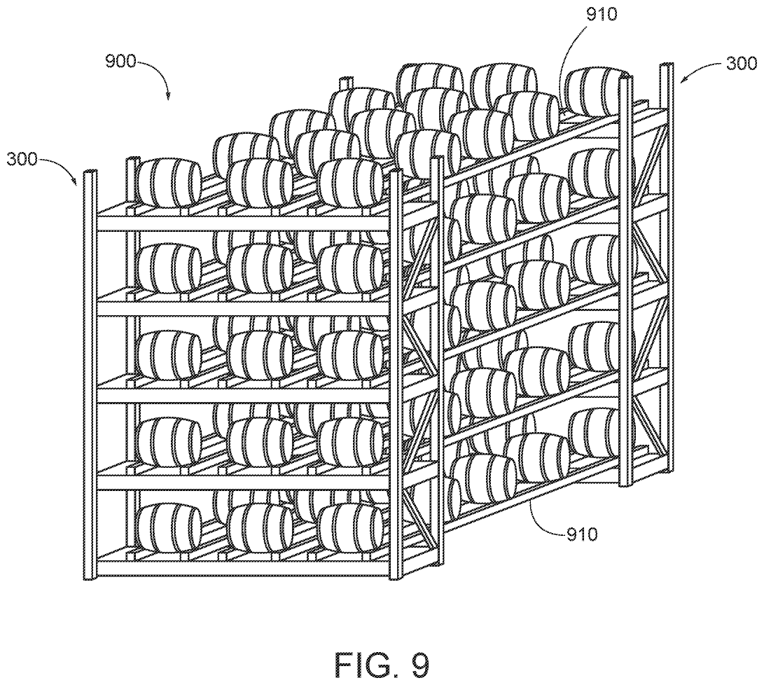

Some exemplary maturation storage facilities may comprise a series of two or more racks (118, 300) that are joined together by bridging members, such as lumber 4x4's for example, that span a gap between the racks and that are configured to hold the barrels. In some examples, two racks (118, 300) such as the ones depicted in FIGS. 4 and 7, are joined together by a plurality of bridging members straddling a gap between the two racks (118, 300) such that each rack structure may hold up to 75 53-gallon barrels. Additional racks (118, 300) may be placed alongside the first two racks (118,300) to form a series, or “block” of racks (118, 300) as desired. By resting barrels on the bridging members, the barrels may shift as a result of movement of the maturation storage facility, thus churning their contents. Referring now to FIG. 9, an exemplary block of racks (900) comprising two racks (300) joined together by a plurality of bridging members (910) on which 75 53-gallon barrels (120) are stored. Blocks of racks (900) may be placed in a barge (100) as shown in FIG. 10, in addition to, or lieu of, individual racks (300) as discussed below.

Referring now to FIG. 10, that figure shows a barge (100) having an overall length (328) of about 195 feet and an interior usable length (326) of about 180 feet. The barge (100) has an overall width (324) of about 35 feet and a usable width (322) of about 28 feet. In this configuration, two rows (301) of storage racks (300) may run the length of the barge, with each row (301) having a width (318) of about 120 inches, and being separated by a path (319) having a width (320) of about 96 inches. Such a configuration provides a high volume of barrel storage, while also allowing room for persons or equipment to move along the length of the barge using the path (319).

Using the layout of FIG. 10 with racks having dimensions similar to that of FIG. 7, it can be seen that five storage racks (300) each capable of holding 15 barrels (120), and having a depth (316) of about 24 inches, can be placed within the 120-inch row (301) width (320). About fifteen of this cluster of five racks (300), each having a length (310) of about 144 inches, can be arranged lengthwise along the barge (100) within the about 2,160-inch usable length (326). With fifteen rack clusters, each cluster having five storage racks, and each storage rack holding fifteen barrels (120), each row (301) can hold about 1,125 barrels (120). This would give the barge (100) of FIG. 10 a total capacity of about 2,250 barrels (120). Some configurations may remove one or more rack (300) clusters in order to allow room for a loading area (303) where heavy equipment may be brought into the barge, or for additional storage for objects besides barrels (120) or racks (300).

Some configurations may also increase or decrease the number of racks (300) within a cluster, which would impact the overall number of barrels (120) that could be stored. For example, in some configurations where the path (319) can be narrowed due to the availability of low profile loading equipment or other methods for moving along the barge, adding additional racks (300) to each cluster could increase barrel storage to about 3000 or more.

While the examples of FIGS. 7-9 show one possible implementation of the disclosed technology and method for storing barrels for aging, it should be understood that other barrel sizes, rack dimensions, and barge sizes and layouts exist and are possible using the techniques described herein, and such variations will be apparent to one of ordinary skill in the art in light of the disclosure herein.

While the descriptions above have focused on the characteristics and advantages of a maturation storage facility that sits in or upon a body of water, it should be understood that the teachings herein apply generally to any facility which is designed to take advantage of the passive characteristics of a location in order to create favorable conditions for factors such as temperature, humidity, and motion, in order to speed the maturation time of alcohol spirits, reduce the amount of spirits lost to leakage and evaporation, or both. For example, a facility located above an underground water source can rely on that underground water source to provide a source of humidity that would be unavailable for a conventional rick house. A facility located above an underground geothermal energy source could rely on that source of heat to create more drastic temperature changes relative to a conventional rick house. A facility located in a high wind area could utilize sails, fins, or other wind deflecting surfaces to catch wind and cause rocking movements on a facility or rack (118, 300) to provide passive churning and mixing. Other facility locations and passive characteristics that may be harnessed to the benefit of alcohol spirit maturation will be apparent to one of ordinary skill in the art in light of the disclosure herein.

Further variations on, features for, and applications of the inventor's technology will be apparent to, and could be practiced without undue experimentation by, those of ordinary skill in the art in light of this disclosure. Accordingly, the protection accorded by this document, or by any related document, should not be limited to the material explicitly disclosed herein.

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A storage facility comprising a set of walls, floor, and ceiling, wherein the walls, floor and ceiling may be thermally conductive, the storage facility having an interior storage area containing a plurality of racks, each rack of the plurality of racks is adapted to hold one or more containers of alcohol spirits, wherein the storage facility is exposed to solar energy from the sun, wherein the thermally conductive walls and ceiling radiate heat from the solar energy into the interior storage area, and wherein the interior storage area is adapted to store heated air within.

### Example 2

The storage facility of any other example, wherein the storage facility is placed upon a body of water, wherein the body of water draws heat away from the thermally conductive walls and floor.

### Example 3

The storage facility of any other example, wherein the storage facility is a decommissioned barge.

### Example 4

The storage facility of any other example, wherein the storage facility is placed upon a body of water, wherein the body of water causes the storage facility to move under the force of waves, currents, or the nearby passage of vessels, and wherein the containers are churned as the storage facility moves.

### Example 5

The storage facility of any other example, wherein the containers are wood barrels, and wherein the alcohol spirits are whiskey.

### Example 6

The storage facility of any other example, wherein the storage facility is between about 180 and about 300 feet long, between about 25 and about 55 feet wide, and between about 10 and about 20 feet deep.

### Example 7

The storage facility of any other example, wherein the storage facility comprises one or more fiberglass covers that may be removed to allow access to the interior storage area, and wherein the fiberglass covers are adapted to trap heated air within the interior storage area when closed.

### Example 8

The storage facility of any other example, further comprising a set of sensors, the set of sensors comprising a temperature sensor and a humidity sensor, wherein the set of sensors is configured to generate a set of data, the set of data indicating one or more characteristics of the interior storage area.

1-20. (canceled)

21. A method for aging spirits comprising:
(a) mooring a barge at a location on a volume of water to prevent substantial movement of the barge from the location;
(b) placing a plurality of storage racks within an interior storage area of the barge;
(c) placing a plurality of barrels containing spirits on the plurality of storage racks; and
(d) aging the plurality of barrels containing spirits at the location for a period of time of at least 6 months prior to removing the plurality of barrels from the interior storage area.

22. The method of claim 21, wherein the plurality of barrels are wood barrels, and wherein the spirits are whiskey.

23. The method of claim 21, wherein the plurality of barrels comprises at least 2000 barrels.

24. The method of claim 23, wherein the plurality of storage racks is arranged in two rows, and separated by a path having a width of about 96 inches.

25. The method of claim 21, wherein the barge is between about 180 and about 300 feet long, between about 25 and about 55 feet wide, and between about 10 and about 20 feet deep.

26. The method of claim 21, further comprising aging the plurality of barrels containing spirits at the location for the period of time of at least 12 months prior to removing the plurality of barrels from the interior storage area.

27. The method of claim 21, further comprising positioning one or more fiberglass covers to allow the interior storage area to take on water from rainfall.

28. The method of claim 27, further comprising positioning the one or more fiberglass covers to substantially prevent the interior storage area from taking on water from rainfall when a surface level of pooled water within the interior storage area is proximate to any barrel of the plurality of barrels.

29. The method of claim 21, further comprising:
(a) collecting a dataset from a set of sensors positioned within the interior storage area during the period of time; and
(b) associating the dataset with the plurality of barrels, wherein the dataset comprises a set of temperature measurements and a set of humidity measurements.

30. The method of claim 29, further comprising producing a set of marketing information for the plurality of barrels based on the set of temperature measurements and the set of humidity measurements.

31. The method of claim 21, wherein the location is on a river or a lake.

32. The method of claim 21, further comprising adding a set of spacers to the plurality of storage racks that are adapted to, for each barrel of the plurality of barrels, hold that barrel in place and allow free flow of air about a majority of the surface of that barrel.

33. The method of claim 32, further comprising adding the set of spacers to separate a barrel of the plurality of barrels from any adjacent barrel by a distance of at least twelve inches.

34. The method of claim 21, further comprising:
(a) coupling one or more cables to the barge;
(b) changing a length of the one or more cables to shift the orientation of the barge at the location and churn the spirits within the plurality of barrels; and
(c) returning the length of the one or more cables to an original length to shift the orientation of the barge at the location and churn the spirits within the plurality of barrels.

35. The method of claim 21, further comprising:
(a) operating a pump within the interior storage area to maintain a pool of water within the interior storage area and achieve a desired level of humidity; and
(b) operating a set of vents to vent air from the interior storage area and achieve a desired level of temperature and the desired level of humidity.

36. The method of claim 21, further comprising:
(a) receiving data from an air sensor within the interior storage area indicating a danger; and
(b) in response to the danger, operating a set of vents to vent air from the interior storage area and replace it with air from the exterior of the interior storage area.

37. A method for aging spirits comprising:
(a) mooring a barge at a location on a volume of water to prevent substantial movement of the barge from the location;
(b) placing a plurality of storage racks within an interior storage area of the barge;
(c) sealing spirits within a plurality of barrels;
(d) while the spirits within the plurality of barrels are unaged, placing the plurality of barrels on the plurality of storage racks;
(e) aging the plurality of barrels containing spirits at the location for a period of time of at least 6 months prior to removing the plurality of barrels from the interior storage area;
collecting a dataset from a set of sensors positioned within the interior storage area during the period of time, wherein the dataset comprises a set of temperature measurements, a set of humidity measurements, and a set of air composition measurements;
(g) operating a set of climate control devices to achieve a desired humidity based on the set of humidity measurements and a desired temperature based on the set of temperature measurements; and
(h) operating a set of safety devices to respond to a detected danger based on the set of air composition measurements.

38. The method of claim 37, wherein the set of climate control devices comprises a pump and an exhaust vent, and wherein the set of safety devices comprises an exhaust vent and a fire alarm.

39. The method of claim 37, further comprising producing a set of marketing information for the plurality of barrels based on the set of temperature measurements and the set of humidity measurements.

40. A method for aging spirits comprising:
(a) mooring a barge at a location on a volume of water to prevent substantial movement of the barge from the location;
(b) placing a plurality of storage racks within an interior storage area of the barge;
(c) sealing spirits within a plurality of barrels;
(d) while the spirits within the plurality of barrels are unaged, placing the plurality of barrels on the plurality of storage racks;
(e) aging the plurality of barrels containing spirits at the location for a period of time of at least 6 months prior to removing the plurality of barrels from the interior storage area;
(f) positioning one or more fiberglass covers to allow the interior storage area to take on water from rainfall and form a pool of water;
(g) positioning the one or more fiberglass covers to substantially prevent the interior storage area from taking on water from rainfall when a surface level of the pool of water is proximate to any barrel of the plurality of barrels; and
(h) adding a set of spacers to the plurality of storage racks that are adapted to, for each barrel of the plurality of barrels, hold that barrel in place and separate that barrel from any horizontally adjacent barrel by a distance of at least twelve inches.
